(19) United States
(12) Patent Application Publication
(10) Pub. No.: US 2014/0315103 A1
(43) Pub. Date: Oct. 23, 2014

(54) SOLID ELECTROLYTE

(71) Applicant: IDEMITSU KOSAN CO., LTD., Tokyo (JP)

(72) Inventor: Hiroyuki Higuchi, Sodegaura-shi (JP)

(73) Assignee: IDEMITSU KOSAN CO., LTD., Chiyoda-ku (JP)

(21) Appl. No.: 14/362,315

(22) PCT Filed: Nov. 29, 2012
(86) PCT No.: PCT/JP2012/007670

§ 371 Date: Jun. 2, 2014

(30) Foreign Application Priority Data
Dec. 2, 2011 (JP) 2011-264797

(51) Int. Cl. H01M 10/0562; H01M 10/052

(52) U.S. Cl. CPC H01M 10/0562; H01M 10/052
USPC 429/322; 423/303; 423/300

(57) ABSTRACT

A solid electrolyte including as constituent components, lithium, phosphorous and sulfur; wherein, in the ³¹P-NMR, the solid electrolyte has a peak (first peak) in a region of 81.0 ppm or more and 88.0 ppm or less, the solid electrolyte does not have a peak in regions other than the region of 81.0 ppm or more and 88.0 ppm or less, or even if it has a peak in other regions than the region of 81.0 ppm or more and 88.0 ppm or less, the peak intensity thereof relative to the first peak is 0.5 or less, and the solid electrolyte has an ionic conductivity of 5×10⁻⁴ S/cm or more.

### TECHNICAL FIELD

The invention relates to a solid electrolyte, and an electrolyte layer, an electrode and a battery produced by using the same.

### BACKGROUND ART

In the field of an all-solid battery, conventionally, a sulfide-based solid electrolyte material has been known. For example, Patent Document 1 reports that, by mixing Li₂S and P₂S₅ at a specific molar ratio (68:32 to 73:27), subjecting the mixture to a mechanical milling treatment, followed by a heat treatment, glass ceramics electrolyte particles having a high ionic conductivity (2×10⁻³S/cm or less) can be obtained.

However, the material disclosed in Patent Document 1 tends to generate hydrogen sulfide easily by contacting water (hydrolysis), and hence, the use thereof in a high dew point environment is limited.

It is known that glass electrolyte particles obtained by mixing Li₂S and P₂S₅ at a molar ratio of 75:25 and then subjecting to a mechanical milling treatment are hardly hydrolyzed (Patent Document 2, for example). However, in the technology of Patent Document 2, although the tendency of easily hydrolyzed is suppressed, the ionic conductivity is significantly lowered.

### RELATED ART DOCUMENT

### Patent Documents

Patent Document 1: JP-A-2005-228570

Patent Document 2: JP-A-2010-199033

### SUMMARY OF THE INVENTION

An object of the invention is to provide a solid electrolyte that is hardly hydrolyzed and has a high ionic conductivity.

According to the invention, the following solid electrolyte or the like are provided.

1. A solid electrolyte comprising, as constituent components, lithium, phosphorous and sulfur;

wherein,

in the ³¹P-NMR,

the solid electrolyte has a peak (first peak) in a region of 81.0 ppm or more and 88.0 ppm or less,

the solid electrolyte does not have a peak in regions other than the region of 81.0 ppm or more and 88.0 ppm or less,

or even if it has a peak in other regions than the region of 81.0 ppm or more and 88.0 ppm or less, the peak intensity thereof relative to the first peak is 0.5 or less, and

the solid electrolyte has an ionic conductivity of 5×10⁻⁴ S/cm or more.

2. A solid electrolyte comprising, as constituent components, lithium or sodium; phosphorous; and sulfur:

wherein the solid electrolyte has an ionic conductivity of 5×10⁻⁴ S/cm or more, and

when air having a humidity of 80 to 90% is passed through a 100 ml-container filled with 0.1 g of the solid electrolyte at a rate of 500 ml/min for 60 minutes, an average of a hydrogen sulfide concentration in the air is 200 ppm or less.

3. The solid electrolyte according to 2, that is obtained by elevating the temperature of glass comprising, as constituent components, lithium or sodium; phosphorous; and sulfur, at an average temperature elevation rate of 20° C./min or more and heating at a temperature that is equal to or higher than a glass transition temperature of the glass and that is equal to or lower than a crystallization temperature of the glass plus 120° C. for 0.005 minute to 10 hours.
4. The solid electrolyte according to 1, wherein, when air having a humidity of 80 to 90% is passed through a 100 ml-container filled with 0.1 g of the solid electrolyte at a rate of 500 ml/min for 60 minutes, an average of a hydrogen sulfide concentration in the air is 200 ppm or less.
5. The solid electrolyte according to any of 1 to 4 further comprising a halogen as a constituent component.
6. An electrolyte layer comprising the solid electrolyte according to any of 1 to 5.
7. An electrolyte layer that is produced by using the solid electrolyte according to any of 1 to 5.
8. An electrode comprising the solid electrolyte according to any of 1 to 5.
9. An electrode that is produced by using the solid electrolyte according to any of 1 to 5.
10. A battery comprising at least one of the electrolyte layer according to 6 and 7 and the electrodes according to 8 and 9.
11. A battery wherein at least one of a positive electrode layer, an electrolyte layer and a negative electrode layer is produced by using the solid electrolyte according to any of 1 to 5.
12. A method for producing a solid electrolyte comprising:

elevating a temperature of glass comprising: lithium or sodium; phosphorous; and sulfur at an average temperature elevation rate of 20° C./min or more; and

heating the glass at a temperature for a time period of from 0.005 minute to 10 hours, wherein the temperature is equal to or higher than a glass transition temperature of the glass, and the temperature is equal to or lower than a crystallization temperature of the glass plus 120° C.

13. The method for producing a solid electrolyte according to 12,

wherein

in the ³¹P-NMR,

a solid electrolyte to be produced has a peak (first peak) in a region of 81.0 ppm or more and 88.0 ppm or less,

the solid electrolyte does not have a peak in regions other than the region of 81.0 ppm or more and 88.0 ppm or less,

or even if it has a peak in regions other than the region of 81.0 ppm or more and 88.0 ppm or less, the peak intensity thereof relative to the first peak is 0.5 or less, and

the solid electrolyte has an ionic conductivity of 5×10⁻⁴ S/cm or more.

14. The method for producing a solid electrolyte according to 12 or 13, wherein a solid electrolyte to be produced has an ionic conductivity of 5×10⁻⁴ S/cm or more, and

when air having a humidity of 80 to 90% is passed through a 100 ml-container filled with 0.1 g of the solid electrolyte at a rate of 500 ml/min for 60 minutes, an average of a hydrogen sulfide concentration in the air is 200 ppm or less.

15. The method for producing a solid electrolyte according to any of 12 to 14, wherein the glass is heated together with a compound comprising a halogen element.

According to the invention, a solid electrolyte that is hardly hydrolyzed and has a high ionic conductivity can be provided.

### BRIEF DESCRIPTION OF THE DRAWINGS

FIG. 1 is a view showing an apparatus used in Production Example 3 for producing a sulfide-based glass ceramics;

FIG. 2 is a view showing a relationship between the temperature and the heating time of the solid electrolyte glass heated in Example 1 and Comparative Example 1;

FIG. 3 is a view showing the method for measuring an ionic conductivity in Example 1;

FIG. 4 is a view showing an apparatus for measuring an average hydrogen sulfide concentration in Examples and Comparative Examples; and

FIG. 5 is a view showing one example of the relationship between the wet air circulation time and the hydrogen sulfide concentration in the measurement of an average hydrogen sulfide concentration.

### MODE FOR CARRYING OUT THE INVENTION

### 1. Solid Electrolyte of the Invention

A first solid electrolyte of the invention comprises phosphorous, lithium and sulfur as constituent components, and, in the ³¹P-NMR, has a peak (referred to as a first peak) in a region of 81.0 ppm or more and 88.0 ppm or less, and does not have a peak in regions other than 81.0 ppm or more and 88.0 ppm or less, or, even if it has a peak in regions other than 81.0 ppm or more and 88.0 ppm or less, the intensity ratio of the peak relative to the first peak is 0.5 or less.

When there are a plurality of peaks in a region of 81.0 ppm or more and 88.0 ppm or less, the highest peak among them is taken as the first peak. The peak intensity is defined as a height from the baseline to the peak top.

The region of the first peak is preferably 81.0 ppm or more and 87.0 ppm or less, and more preferably 81.5 ppm or more and 86.5 ppm or less.

If there is a peak in regions other than 81.0 ppm or more and 88.0 ppm or less, the peak intensity of the peak relative to the first peak is preferably 0.45 or less, and more preferably 0.4 or less.

The first solid electrolyte has an ionic conductivity of 5×10⁻⁴ S/cm or more, more preferably 6×10⁻⁴ S/cm or more, and further preferably 7×10⁻⁴ S/cm or more.

Although a higher ionic conductivity is preferable, as the upper limit thereof, 5×10⁻² S/cm can be given, for example.

The above-mentioned solid electrolyte may comprise a halogen in addition to lithium, phosphorous and sulfur.

It is preferred that the solid electrolyte satisfy the following formula (A):

LiₐM_{b}P_{c}S_{d}Xₑ (A)

In the formula (A), a, b, c, d and e are independently a composition ratio of each element and a:b:c:d:e satisfies 1 to 12:0 to 0.2:1:0.1 to 9:0 to 9.

b is preferably 0.

Preferably, the ratio of a, c and d (a:c:d) is 1 to 9:1:3 to 7, and further preferably, 2 to 4.5:1:3.5 to 5.

As mentioned later, the composition ratio of each element can be controlled by adjusting the amount of the raw material compounds used for producing a solid electrolyte.

M is represented by the following formula (B):

B_{f}Zn_{g}SiₕCuᵢGaⱼGeₖ (B)

f to k are independently a composition ratio of each element, are independently 0 or more and 1 or less, and f+g+h+i+j+k=1. It is preferred that f, i and j be 0, and that g and h be independently 0 or more and 1 or less, and g+h+k=1.

X is represented by the following formula (C):

FₗClₘBrₙlₒ (C)

l to o are independently a composition ratio of each element, are independently 0 or more and 1 or less, and l+m+n+o=1. It is preferred that l and m be 0, n and o be independently 0 or more and 1 or less, and n+o=1. It is more preferred that l and m be 0, and n and o be independently 0 or 1, and n+o=1.

It is preferred that, among Ito o, one be 1 and the other be 0.

A second solid electrolyte of the invention comprises lithium or sodium, phosphorous and sulfur as constituent components and has an ionic conductivity of 5×10⁻⁴ S/cm or more. In addition, when placing 0.1 g of the solid electrolyte in a 100 ml-container and passing air having a humidity of 80 to 90% through the container at 500 ml/min for 60 minutes, the second solid electrolyte has an average hydrogen sulfide concentration in the air of 200 ppm or less.

The second solid electrolyte may also comprise a halogen, in addition to lithium or sodium, phosphorous and sulfur. When the second solid electrolyte comprises lithium, phosphorous and sulfur, these constituent components are the same as those of the first solid electrolyte.

If the second solid electrolyte comprises sodium, phosphorous and sulfur, it is preferred that the solid electrolyte satisfy the following formula (A′):

NaₐM_{b}P_{c}S_{d}Xₑ (A)

In the formula (A′), a, b, c, d and e, M and X are the same as those in the above formula (A). The ionic conductivity of the second solid electrolyte is the same as that of the first solid electrolyte.

The second solid electrolyte has an average hydrogen sulfide concentration measured by the above-mentioned method of 200 ppm or less, and has a high hydrolysis resistance. The average hydrogen sulfide concentration is preferably 150 ppm or less, with 130 ppm or less being more preferable.

In general, a sulfide-based solid electrolyte generates hydrogen sulfide when hydrolyzed. Therefore, when hydrolyzed under the same conditions, hydrolysis resistance is high when the generated amount of hydrogen sulfide is small. In the invention, an average hydrogen sulfide concentration obtained by the above-mentioned method is used as an index of hydrolysis resistance. An average hydrogen sulfide concentration is measured by the method described in the Examples.

It is preferred that the first solid electrolyte have the same average hydrogen sulfide concentration measured by the above-mentioned method as that of the second solid electrolyte.

The second solid electrolyte of the invention is a solid electrolyte obtained by elevating the temperature of glass comprising as constituent components lithium or sodium; phosphorous; and sulfur, at an average temperature elevation rate of 20° C./min or more and heating at a temperature for a time period of from 0.005 minute to 10 hours, wherein the temperature is equal to or higher than a glass transition temperature of the glass (Tg) and is equal to or lower than a crystallization temperature of the glass (Tc) plus 120° C.

The method for elevating the temperature of the glass and the method for heating the glass will be mentioned later.

No specific restrictions are imposed on the shape of the first and second solid electrolytes (hereinafter referred to as the “solid electrolyte” of the invention). It may be particulate or in the form of a sheet. The electrolyte of the invention is solid at 25° C.

If the solid electrolyte is particulate, when forming an electrolyte layer, by applying a slurry comprising the solid electrolyte of the invention or an electrolyte precursor, an electrolyte layer can be produced. The solid electrolyte of the invention can be produced by heating glass as an electrolyte precursor.

When an electrolyte sheet is produced by using an electrolyte precursor, after forming an electrolyte layer by using an electrolyte precursor, the electrolyte layer is heated by predetermined heating conditions mentioned later, whereby the electrolyte layer of the invention can be produced.

Further, an electrolyte layer can be produced by using the electrostatic method.

When the solid electrolyte of the invention is in the form of particles, it is preferred that the mean volume diameter be 0.01 μm or more and 500 μm or less.

The mean volume diameter (hereinafter referred to as the “particle diameter”) is preferably measured by a laser diffraction particle diameter distribution measurement method.

In the laser diffraction particle diameter distribution measurement method, it is possible to measure the particle diameter distribution without drying the composition. The particle size distribution can be measured by analyzing the scattered light by irradiating a group of particles in the composition with laser light.

In the invention, the average particle size is measured by using a dry solid electrolyte or sulfide-based glass as a precursor thereof.

If the laser diffraction particle size distribution measurement apparatus is a Mastersizer 2000 manufactured by Malvern Instruments Ltd., the measurement is conducted as follows, for example.

First, 110 ml of dehydrated toluene (special grade: manufactured by Wako Pure Chemical Industries, Ltd.) is put in a dispersion tank of an apparatus. Further, as a dispersant, 6% of tertiary butyl alcohol (special grade: manufactured by Wako Pure Chemical Industries, Ltd.) that has been dehydrated is added.

After fully mixing the above mixture, the “dry solid electrolyte or sulfide-based glass as a precursor thereof” is added to measure the particle size. The amount of the “dry solid electrolyte or sulfide-based glass as a precursor thereof” is added such that, in an operation screen stipulated by the Mastersizer 2000, the intensity of scattered laser light corresponding to the concentration of the particles falls within a specific range (10 to 20%). If the amount exceeds this range, multiple scattering occurs, and an accurate particle size distribution may not be obtained. Further, if the amount is smaller than this range, an SN ratio becomes poor, and an accurate measurement may not be conducted.

In the Mastersizer 2000, since the intensity of scattered laser light is indicated based on the amount of added of the “dry solid electrolyte or sulfide-based glass as a precursor”, it suffices that the amount that falls within the above-mentioned intensity of scattered laser light be found.

As for the added amount of the “dry solid electrolyte or sulfide-based glass as a precursor thereof”, although the optimum amount varies depending on the type or the like of the ionic conductive substance, the amount is about 0.01 g to 0.05 g.

Subsequently, the method for producing the solid electrolyte of the invention will be explained. It is needless to say that the solid electrolyte of the invention is not limited to an electrolyte that is produced by the following production method.

The solid electrolyte of the invention can be produced by heating an electrolyte precursor (glass) or a mixture of the precursor and a compound containing a halogen element by a specific method.

As in the case of the first electrolyte, in the ³¹P-NMR, the electrolyte precursor normally has a peak (hereinafter referred to as the first peak) in a region of 81.0 ppm or more and 88.0 ppm or less, and does not have a peak in regions other than the region of 81.0 ppm or more and 88.0 ppm or less, or even if it has a peak in other regions than the region of 81.0 ppm or more and 88.0 ppm or less, the peak intensity thereof relative to the first peak is 0.5 or less. The electrolyte precursor is a compound that satisfies the above formula (A) or (A′).

The electrolyte precursor can be produced by reacting the following raw material “a” and a compound optionally containing a halogen element by a specific method.

The electrolyte precursor may or may not contain a halogen element. A compound containing a halogen element mentioned later may or may not be added to the electrolyte precursor. No specific restrictions are imposed on the method for mixing the electrolyte precursor and a compound containing a halogen element, and a method in which mixing is conducted in a mortar, a method in which a mechanical milling treatment is conducted or the like can be given.

As the raw material “a”, Li₂S (lithium sulfide), P₂S₃ (phosphorous trisulfide), P₂S₅ (phosphorous pentasulfide), SiS₂ (silicon sulfide), Li₄SiO₄ (lithium orthosilicate), Al₂S₃ (aluminum sulfide), phosphorous simple body (P), sulfur simple body (S), silicon (Si), GeS₂ (germanium sulfide), B₂S₃ (diboron trisulfide), Li₃PO₄ (lithium phosphate), Li₄GeO₄ (lithium germanate), LiBO₂ (lithium metaborate), LiAlO₃ (lithium aluminate) or the like can be used.

As the preferable raw material “a”, Li₂S (lithium sulfide) and P₂S₅ (phosphorous pentasulfide) can be given.

When a solid electrolyte containing sodium, phosphorous and sulfur is produced, as the raw material “a”, instead of the above-mentioned Li-containing compound, a Na-containing compound corresponding thereto can be used.

The method for producing an electrolyte precursor when Li₂S (lithium sulfide) and P₂S₅ (phosphorous pentasulfide) are used as the raw materials “a” will be explained.

No specific restrictions are imposed on the lithium sulfide, and commercially available lithium sulfide can be used. Highly pure lithium sulfide is preferable.

Lithium sulfide can be produced by a method described in JP-A-H07-330312, JP-A-H09-283156, JP-A-2010-163356 and Japanese Patent Application No. 2009-238952.

In the method for producing lithium sulfide described in JP-A-2010-163356, lithium hydroxide and hydrogen sulfide are reacted in a hydrocarbon-based organic solvent at 70° C. to 300° C. to form lithium hydrosulfide, and then the reaction liquid is hydrodesulfurized to synthesize lithium sulfide.

In the method described in Japanese Patent Application No. 2009-238952, lithium hydroxide and hydrogen sulfide are reacted in an aqueous solvent at 10° C. to 100° C. to form lithium hydrosulfide, and then the reaction liquid is hydrodesulfurized to synthesize lithium sulfide.

As for the lithium sulfide, the total content of lithium salts in sulfur oxides is preferably 0.15 mass % or less, more preferably 0.1 mass % or less, and the content of N-methylaminobutyric acid lithium salt is preferably 0.15 mass % or less, more preferably 0.1 mass % or less.

If the total content of lithium salts in sulfur oxides is 0.15 mass % or less, a solid electrolyte obtained by the melt quenching method or the mechanical milling method becomes a glass electrolyte (completely amorphous). On the other hand, if the total content of lithium salts in sulfur oxides exceeds 0.15 mass %, the resulting electrolyte may become a crystallized product from the beginning.

If the content of N-methylaminobutyric acid lithium salt is 0.15 mass % or less, there is no fear that a deteriorated product of N-methylamionobutyric acid lithium salt lowers the cyclic performance of a lithium ion battery. As mentioned above, by using lithium sulfide of which the amount of impurities has been reduced, a highly ionically conductive electrolyte can be obtained.

Since lithium sulfide disclosed in JP-A-H07-330312 and JP-A-H09-283156 contains lithium salts of sulfur oxide or the like, it is preferable to conduct purification.

On the other hand, lithium sulfide produced by the method for producing lithium sulfide disclosed in JP-A-2010-163356 contains a very small amount of lithium salts of sulfur oxides or the like, and hence, it may be used for the production of sulfide-based glass without conducting purification.

As the preferable purification method, for example, a purification method described in WO2005/40039 or the like can be given. Specifically, lithium sulfide obtained as above is washed with an organic solvent at a temperature of 100° C. or higher.

No specific restrictions are imposed on phosphorous pentasulfide (P₂S₅) as long as it is produced and sold on the industrial basis.

The compound comprising a halogen element is a compound represented by the following formula (E), and it may be used singly or in combination of two or more.

Y—X (E)

wherein in the formula, Y is an alkali metal such as lithium, sodium and potassium. Lithium is particularly preferable. X is as defined in the formula (C).

As the compound comprising a halogen element, LiX′ can be given, for example. X′ is a halogen element, and is preferably Br and I. As the compound comprising a halogen element, LiF, LiCl, LiBr, LiI or the like can be given, for example.

The ratio (molar ratio) of lithium sulfide and phosphorous pentasulfide is preferably 60:40 to 90:10, more preferably 65:35 to 85:15, and particularly preferably 67:33 to 80:20.

The ratio (molar ratio) of the total of lithium sulfide and phosphorous pentasulfide to the halogen element is preferably 50:50 to 100:0, more preferably 60:40 to 100:0, and particularly preferably 70:30 to 100:0.

As the method for producing sulfide-based glass (electrolyte precursor), the melt quenching method, the mechanical milling method (MM method), the slurry method in which raw materials are reacted in an organic solvent, the solid phase method or the like can be given.

### (a) Melt Quenching Method

The melt quenching method is described in JP-A-H06-279049 and WO2005/119706, for example.

Specifically, predetermined amounts of P₂S₅, Li₂S and a compound containing a halogen are mixed in a mortar to allow the mixture to be in the form of a pellet, and the resulting pellet is put in a carbon-coated quarts tube and vacuum-sealed. After allowing the pellet to react at a prescribed reaction temperature, the tube is quenched by putting in ice, whereby an electrolyte precursor as sulfide-based glass can be obtained.

The reaction temperature is preferably 400° C. to 1000° C., and more preferably 800° C. to 900° C. The reaction time is preferably 0.1 hour to 12 hours, and more preferably 1 to 12 hours.

The quenching temperature of the above-mentioned reaction product is normally 10° C. or less, preferably 0° C. or less. The cooling rate is normally about 1 to 10000K/sec, and preferably 10 to 10000K/sec.

### (b) Mechanical Milling Method

The mechanical milling method (hereinafter referred to as the “MM method”) is described in JP-A-H11-134937, JP-A-2004-348972 and JP-A-2004-348973.

Specifically, predetermined amounts of P₂S₅, Li₂S and a compound containing a halogen are mixed in a mortar, and the mixture is reacted for a prescribed period of time by means of various ball mills, for example, whereby an electrolyte precursor that is sulfide-based glass is obtained.

In the MM method using the above-mentioned raw materials, a reaction can be conducted at room temperature. According to the MM method, there is an advantage that, since a glass solid electrolyte can be produced at room temperature, thermal decomposition of the raw material does not occur, and an electrolyte precursor that is sulfide-based glass having the same composition as that at the time of preparation can be obtained.

Further, in the MM method, there is an advantage that, simultaneously with the production of an electrolyte precursor that is sulfide-based glass, the raw materials can be finely pulverized. In the MM method, various ball mills including a rotational ball mill, a tumbling ball mill, a vibration ball mill and a planetary ball mill can be used. As for the conditions of the MM method, when a planetary ball mill is used, for example, a treatment is conducted with a rotation speed of several tens to several hundreds rotations per minute for a period of 0.5 hour to 100 hours.

As described in JP-A-2010-90003, as for the ball for the ball mill, balls differing in diameter may be used in combination. Further, as described in JP-A-2009-110920 or in JP-A-2009-211950, an organic solvent may be added to the raw material to allow it to be a slurry, and the slurry may be subjected to a mechanical milling treatment. As described in JP-A-2010-30889, the temperature inside the mill at the time of the mechanical milling treatment may be adjusted.

It is preferred that the raw treatment temperature at the time of the mechanical milling treatment be 60° C. or higher and 160° C. or lower.

### (c) Slurry Method

The slurry method is stated in WO2004/093099 and WO2009/047977.

Specifically, by reacting prescribed amounts of P₂S₅ particles, Li₂S particles and a compound containing a halogen in an organic solvent for a prescribed period of time, a solid electrolyte precursor that is sulfide-based glass can be obtained.

It is preferred that a compound comprising a halogen be dissolved in an organic solvent, or be in the form of particles.

As described in JP-A-2010-140893, in order to promote the reaction, the reaction may be conducted while circulating the slurry containing the raw material between the beads mill and a reaction apparatus.

Further, as described in WO2009/047977, a reaction can be proceeded efficiently by pulverizing in advance lithium sulfide as the raw material.

In addition, as described in Japanese Patent Application No. 2010/270191, in order to increase the specific surface area, lithium sulfide as the raw material may be immersed in a polar solvent (methanol, diethyl carbonate, acetonitrile, or the like) having a dissolution parameter of 9.0 or more for a prescribed period of time.

The reaction temperature is preferably 20° C. or higher and 80° C. or lower, with 20° C. or higher and 60° C. or lower being more preferable. The reaction time is preferably 1 hour or more and 16 hours or less, more preferably 2 hours or more and 14 hours or less.

It is preferred that an organic solvent may be added such that, lithium sulfide, lithium pentasulfide and a compound comprising a halogen as raw materials become in the state of a solution or a slurry by addition of an organic solvent. Normally, the amount of the raw materials (total amount) relative to 1 liter of the organic solvent is about 0.001 kg or more and 1 kg or less. The amount of the raw material is preferably 0.005 kg or more and 0.5 kg or less, with 0.01 kg or more and 0.3 kg or less being particularly preferable.

Although no particular restrictions are imposed on the organic solvent, a non-protonic organic solvent is particularly preferable.

As the non-protonic organic solvent, a non-protonic organic solvent (for example, hydrocarbon-based organic solvent), a non-protonic polar organic compound (an amide compound, a lactam compound, a urea compound, an organic sulfur compound, a cyclic organic phosphorous compound or the like, for example) can preferably be used as a single solvent or a mixed solvent.

As the hydrocarbon-based organic solvent, a saturated hydrocarbon, an unsaturated hydrocarbon or an aromatic hydrocarbon can be used.

Examples of the saturated hydrocarbon include hexane, pentane, 2-ethylhexane, heptane, decane and cyclohexane. As the unsaturated hydrocarbon, hexene, heptene, cyclohexene or the like can be given. As the aromatic hydrocarbon, toluene, xylene, decalin, 1,2,3,4-tetrahydronaphthalene and the like can be given.

Among them, toluene and xylene are particularly preferable.

It is preferred that the hydrocarbon-based solvent be dehydrated in advance. Specifically, as the water content, 100 wt. ppm or less is preferable, with 30 wt. ppm or less being particularly preferable.

According to need, other solvents may be added to the hydrocarbon-based solvent. Specific examples thereof include ketones such as acetone and methyl ethyl ketone, ethers such as tetrahydrofuran, alcohols such as ethanol and butanol, esters such as ethyl acetate and halogenated hydrocarbons such as dichloromethane and chlorobenzene.

### (d) Solid Phase Method

The solid phase method is stated in a Non-Patent Document: “H-J, Deiseroth, et. al., Angew. Chem. Int. Ed. 2008, 47, 755-758”, for examples. Specifically, prescribed amounts of P₂S₅, Li₂S and a compound comprising a halogen are mixed in a mortar, followed by heating at 100 to 900° C., whereby a precursor of an electrolyte of the invention that is sulfide-based glass can be obtained.

The production conditions such as the temperature conditions, the treatment time, and the charged amount or the like of the melt quenching method, the MM method, the slurry method and the solid phase method can be appropriately adjusted according to equipment used or the like.

As the method for producing sulfide-based glass, the MM method, the slurry method or the solid phase method is more preferable. Due to capability of production at a low cost, the MM method and the slurry method are more preferable, with the slurry method being particularly preferable.

A solid electrolyte can be obtained by subjecting the sulfide-based glass to a heat treatment. It is preferred that the heat treatment be conducted at a dew point of −40° C. or less, more preferably at a dew point of −60° C. or less.

The pressure at the time of heating may be normal pressure or reduced pressure. The atmosphere may be air or inert gas. Further, as described in JP-A-2010-186744, heating may be conducted in a solvent (for example, a hydrocarbon-based organic solvent).

The heat treatment temperature is preferably equal to or higher than the Tg of the electrolyte precursor, and is equal to or lower than the Tc plus 120° C. of the electrolyte precursor (Tg: glass transition temperature, Tc: crystallization temperature). If the heat treatment temperature is lower than Tg, the production of the solid electrolyte may be significantly long.

For example, when Tg is 170° C. and Tc is 230° C., the heat treatment temperature is 170° C. or higher and 350° C. or lower, preferably 175° C. or higher and 330° C. or lower.

If the heat treatment temperature exceeds (Tc plus 120° C.), the solid electrolyte after the heat treatment contains impurities, and the ionic conductivity may be lowered. The heat treatment temperature is more preferably (Tg plus 5° C.) or more and (Tc plus 110° C.) or less, and further preferably (Tg plus 10° C.) or more and (Tc plus 100° C.) or less.

The heat treatment time is preferably 0.005 minute or longer and 10 hours or shorter, further preferably 0.005 minute or longer and 5 hours or shorter, and particularly preferably 0.01 minute or longer and 3 hours or shorter.

If the heat treatment time is shorter than 0.005 minute, the solid electrolyte after the heat treatment may contain a large amount of an electrolyte precursor, leading to lowering in ionic conductivity. If the heat treatment temperature exceeds 10 hours, the solid electrolyte after the heat treatment contains impurities, and the ionic conductivity may be lowered.

As for elevating the temperature elevation method, it is preferred that the temperature be elevated rapidly to the above-mentioned heat treatment temperature.

For example, the average temperature elevation rate is 20° C./min or more. If the average temperature elevation rate is less than 20° C./min, the ionic conductivity may not be fully increased. It is further preferred that the average temperature elevation rate be 50° C./min or more, with 100° C./min or more being particularly preferable.

Although the upper limit of the average temperature elevation rate is not particularly restricted, it is 20000° C./min or less, for example.

### 2. Electrolyte-Containing Product

The electrolyte-containing product of the invention comprises the above-mentioned solid electrolyte.

The electrolyte-containing product of the invention may only comprise the above-mentioned solid electrolyte, may further comprise a compound containing a halogen element and may comprise an organic solvent. Further, at least one of the following binder, positive electrode active material, negative electrode active material and conductive aid may be contained.

### 3. Electrolyte Layer

The electrolyte layer of the invention may be an electrolyte layer that constitutes a battery or may be in the form of a sheet.

### (1) First Electrolyte Layer

The first electrolyte layer is an electrolyte layer comprising the above-mentioned solid electrolyte. It may comprise other electrolytes than the above-mentioned electrolyte. It may comprise the following binder.

### (2) Second Electrolyte Layer

The second electrolyte layer may be an electrolyte layer that is produced by using the above-mentioned solid electrolyte. It may only be produced by using the above-mentioned solid electrolyte. For example, it may be produced by applying a slurry containing the above-mentioned solid electrolyte, the binder mentioned later and a solvent, or alternatively, it may be produced by the electrostatic coating method by using the above-mentioned solid electrolyte in the form of particles.

### 4. Electrode

The electrode of the invention may be an electrode layer that constitutes a battery and may be in the form of a sheet.

### (1) First Electrode

The first electrode may comprise the above-mentioned solid electrolyte and, ordinary, contains an active material. The first electrode may comprise other electrolytes than the above-mentioned solid electrolyte. It may comprise the binder mentioned later. As the active material, a positive electrode active material and a negative electrode active material mentioned later can be given.

### (2) Second Electrode

The second electrode is an electrode that is produced by using the above-mentioned solid electrolyte and ordinary contains an active material. It may comprises other electrolytes than the above-mentioned solid electrolyte, and it may comprise a binder mentioned later. As the active material, a positive electrode active material and a negative electrode active material mentioned later can be given.

The second electrode may only be produced by using the above-mentioned solid electrolyte. For example, it may be produced by applying a slurry comprising the above-mentioned solid electrolyte, and the active material (mentioned later), the binder (mentioned later) and a solvent. It may be produced by the electrostatic coating method by using, among the solid electrolyte and the active material, one that is in the form of particles.

### 5. Battery

### (1) First Battery

A first electrode of the invention is a battery in which at least one of the positive electrode layer, the electrolyte layer and the negative electrode layer comprises the electrolyte of the invention. Each layer can be produced by a known method.

When the positive electrode layer, the negative electrode layer and/or the electrolyte layer are produced by using the electrolyte precursor, after the positive electrode layer or the like is produced by using the electrolyte precursor, heating is conducted by the above-mentioned prescribed heating conditions, whereby the first battery of the invention can be produced.

Each layer of the above-mentioned battery will be explained below.

### (A) Positive Electrode Layer

It is preferred that the positive electrode layer contain a positive electrode active material, the electrolyte and a conductive aid. Further, if need arises, a binder may be contained.

### (i) Positive Electrode Active Material

As the positive electrode active material, a material into which a lithium ion can be inserted and from which a lithium ion can be removed and a material that is known as the positive electrode active material in the battery field can be used.

For example, oxides such as V₂O₅, LiCoO₂, LiNiO₂, LiMnO₂, LiMn₂O₄, Li(NiₐCo_{b}Mn_{c})O₂ (0<a<1, 0<b<1, 0<c<1, a+b+c=1), LiNi_{1-Y}Co_{Y}O₂, LiCo_{1-Y}Mn_{Y}O₂, LiNi_{1-Y}Mn_{Y}O₂(0≦Y<1), Li(NiₐCoNn_{c})O₄ (0<a<2, 0<b<2, 0<c<2, a+b+c=2), LiMn_{2-Z}Ni_{Z}O₄, LiMn_{2-Z}Co_{Z}O₄(0<Z<2), LiCoPO₄, LiₓFePO₄, bismuth oxide (Bi₂O₃), bismuth plumbate (Bi₂Pb₂O₅), copper oxide (CuO), vanadium oxide (V₆O₁₃), LiₓCoO₂, LiₓNiO₂, LiₓMn₂O₄, LiₓFePO₄, LiₓCoPO₄, LiₓMn_{1/3}Ni_{1/3}Co_{1/3}O₂, LiₓMn_{1.5}Ni_{0.5}O₂ or the like can be given.

As for the positive electrode active material other than those mentioned above, for example, as the sulfide-based positive electrode active material, a simple body of sulfur (S), titanium sulfide (TiS₂), molybdenum sulfide (MoS₂), iron sulfide (FeS, FeS₂), copper sulfide (CuS) and nickel sulfide (Ni₃S₂), lithium sulfide (Li₂S), niobium selenide (NbSe₃), an organic disulfide compound, a carbon sulfide compound, sulfur, indium or the like can be used. Preferably, S and Li₂S having a high theoretical capacity can be used.

An organic disulfide compound and a carbon sulfide compound are exemplified below.

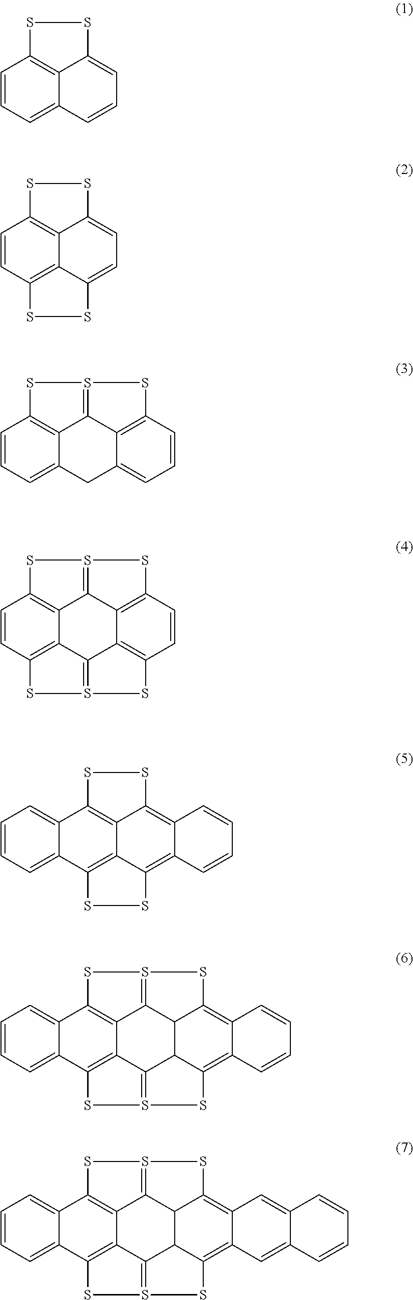

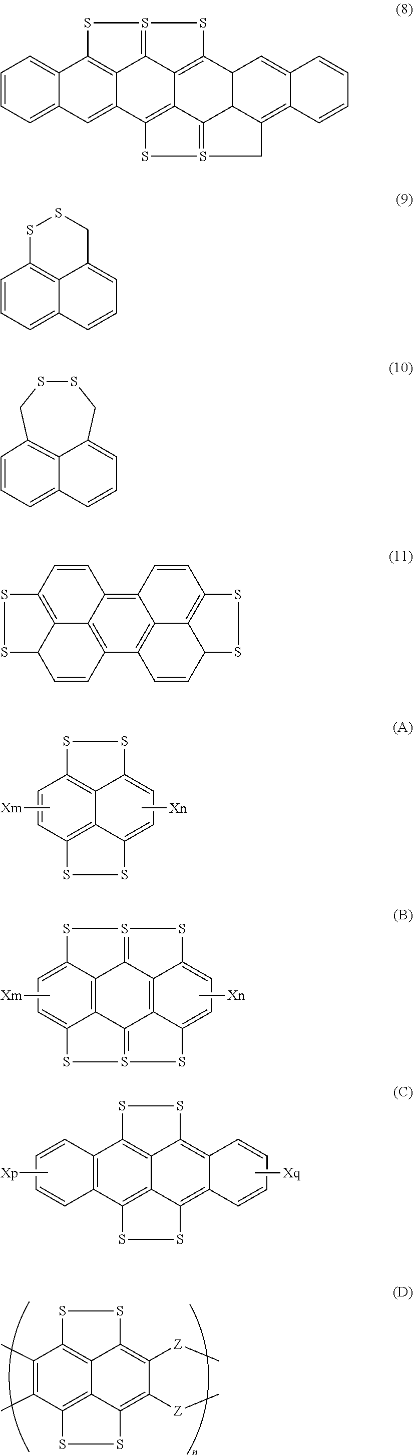

In the formulas (A) to (C), Xs are independently a substituent; n and m are independently an integer of 1 or 2; and p and q are independently an integer of 1 to 4.

In the formula (D), Zs are independently —S— or —NH— and n is a repeating number and an integer of 2 to 300.

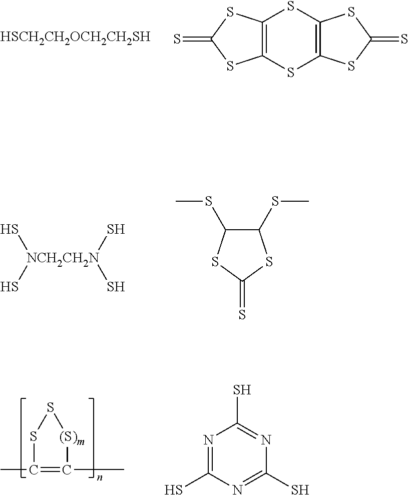

### (ii) Electrolyte

The electrolyte is at least one of a polymer-based solid electrolyte, an oxide-based solid electrolyte, the solid electrolyte or the electrolyte precursor of the invention.

### (a) Polymer-Based Solid Electrolyte

No specific restrictions are imposed on the polymer-based solid electrolyte. For example, as disclosed in JP-A-2010-262860, a material that can be used as the polymer electrolyte such as a fluorine resin, polyethylene oxide, polyacrylonitrile, polyacrylate or its derivatives or copolymers can be given.

As the fluorine resin, for example, those comprising vinylidene fluoride (VdF), hexafluoropropylene (HFP), tetrafluoroethylene (TFE) or the derivatives thereof as structural units can be given. Specifically, homopolymers such as polyvinylidene fluoride (PVdF), polyhexafluoropropylene (PHFP), polytetrafluoroethylene (PTFE), binary copolymers or tertiary copolymers such as copolymer of VdF and HFP (hereinafter, these copolymers may be referred to as “P(VdF-HFP)” can be given.

### (b) Oxide-Based Solid Liquid Electrolyte

As the oxide-based solid electrolyte, LiN, LISICONs, Thio-LISICONs and crystals having a Perovskites structure such as La_{0.55}Li_{0.35}TiO₃, LiTi₂P₃O₁₂ having a NASICON structure, and electrolytes obtained by crystallization of these can be used.

(iii) Conductive Aid

The conductive aid may only have conductivity. The conductivity of the conductive aid is preferably 1×10³S/cm or more, more preferably 1×10⁵S/cm or more.

As the Conductive aid, a material selected from a carbon material, metal powder and a metal compound or a mixture thereof can be given.

As specific examples of the conductive aid, a material comprising at least one element selected from the group consisting of carbon, nickel, copper, aluminum, indium, silver, cobalt, magnesium, lithium, chromium, gold, ruthenium, platinum, beryllium, iridium, molybdenum, niobium, osmium, rhodium, tungsten and zinc is preferable.

A carbon simple body, a metal simple body, a mixture or a compound comprising carbon, nickel, copper, silver, cobalt, magnesium, lithium, ruthenium, gold, platinum, niobium, osmium or rhodium, each having a high ionic conductivity, are more preferable.

Specific examples of the carbon materials include carbon black such as ketjen black, acetylene black, denka black, thermal black and channel black, graphite, carbon fibers and active carbon or the like can be given. They may be used singly or in combination of two or more.

Among these, acetylene black, denka black and ketjen black having high electron conductivity are preferable.

### (iv) Binder

The positive electrode layer may comprise a binder. As the binder, a fluorine-containing resin such as polytetrafluoroethylene (PTFE), polyvinylidene fluoride (PVDF) and fluorine rubber, a thermoplastic resin such as polypropylene and polyethylene, an ethylene-propylene-diene monomer (EPDM), sulfonated EPDM, natural butyl rubber (NBR) or the like can be used singly or in a mixture of two or more.

In addition, a cellulose-based binder as a water-based binder, a water dispersion of styrene-butadiene rubber (SBR) or the like can also be used.

No specific restrictions are imposed on the ratio of the positive electrode active material, the electrolyte and the conductive aid or the like, and a known ratio can be used, for example.

The thickness of the positive electrode layer is preferably 0.01 mm or more and 10 mm or less. The positive electrode layer can be produced by a known method. For example, it can be produced by the coating method and the electrostatic method (electrostatic spray method, electrostatic screening method, or the like).

### (B) Negative Electrode Layer

It is preferred that the negative electrode layer comprise a negative electrode active material, an electrolyte and a conductive aid.

The positive electrode layer differs from the negative electrode layer only in that the electrode active material is a positive electrode active material or a negative electrode active material. Therefore, an explanation is made only on the negative electrode active material, and an explanation of the same matters as those of the positive electrode layer will be omitted here.

### (i) Negative Electrode Active Material

As the negative electrode active material, a material into which lithium ions can be inserted or from which lithium ions can be removed or a known material as a negative electrode active material known in the field of a battery can be used.

For example, a carbon material; specifically, artificial graphite, graphite carbon fibers, resin baked carbon, thermally decomposed vapor-grown carbon, coke, mesocarbon microbeads (MCMB), furfuryl alcohol resin baked carbon, polyacene, pitch-based carbon fibers, vapor-grown carbon fibers, natural graphite, hardly graphitizable carbon or the like can be given. A mixture of these may be used. Of them, artificial graphite is preferable.

In addition, a metal such as lithium, indium, aluminum and silicon or an alloy obtained by combining these metals with other elements and compounds can be used as a negative electrode material. Among them, silicon, tin and lithium having a high theoretical capacity are preferable.

### (C) Electrolyte Layer

The electrolyte layer may comprise a solid electrolyte and may also comprise a binder.

It is preferred that the solid electrolyte of the electrolyte layer be fused. Here, the “fused” means that part of the solid electrolyte particles is dissolved and the dissolved part is integrated with other solid electrolyte particles.

The electrolyte layer may be in the form of a plate of the solid electrolyte. It may include a case where part or all of the solid electrolyte particles are dissolved to be in the form of a plate.

It is preferred that the thickness of the electrolyte layer be 0.001 mm or more and 1 mm or less.

Since the electrolyte and the binder are the same as those for the positive electrode layer, an explanation thereof is omitted.

### (D) Current Collector

As the current collector, a known current collector can be used. For example, a layer obtained by covering one that reacts with a sulfide-based solid electrolyte, such as Au, Pt, Al, Ti or Cu, with Au or the like, can be used.

### (2) Second Battery

A second battery of the invention is a battery in which at least one of the positive electrode layer, the electrolyte layer and the negative electrode layer is produced by using the above-mentioned electrolyte of the invention.

The first battery and the second battery differ only in that, in the second battery, at least one of the positive electrode layer, the electrolyte layer and the negative electrode layer is produced by using the solid electrolyte that is produced by using the electrolyte of the invention. Therefore, an explanation on the similar matters will be omitted.

Hereinabove, an explanation is given on the lithium-based electrode. An alkali metal-based electrolyte such as a sodium-based alkali metal-based electrolyte, a divalent cationic electrolyte such as a magnesium-based electrolyte or the like exhibit similar advantageous effects to those mentioned above.

### EXAMPLES

### Production Example 1

### Production and Purification of Lithium Sulfide (Li₂S)

Lithium sulfide was produced and purified according to the method described in WO2005/040039.

Specifically, it was produced as follows.

### (1) Production of Lithium Sulfide (Li₂S)

Lithium sulfide was produced according to the method of the first aspect (two-step method) described in JP-A-H07-330312. Specifically, 3326.4 g (33.6 mol) of N-methyl-2-pyrrolidone (NMP) and 287.4 g (12 mol) of lithium hydroxide were charged in a 10 liter-autoclave provided with a stirring blade, and heated to at 300 rpm to 130° C. After elevating the temperature, hydrogen sulfide was blown to the resulting liquid at a supply rate of 3 liter/minute for 2 hours.

Subsequently, this reaction liquid was heated under the stream of nitrogen (200 cc/min), thereby to hydrodesulfurize a part of reacted hydrogen sulfide. With an increase in temperature, water generated as a side product due to the reaction of the above-mentioned hydrogen sulfide and lithium hydroxide began to evaporate. The evaporated water was condensed using a condenser and removed to the outside of the system. The temperature of the reaction liquid rose while water was distilled away out of the system. Heating was stopped at the point where the temperature reached 180° C., and the reaction liquid was maintained at a certain temperature. After the completion of hydrodesulfurization (about 80 minutes), the entire reaction was completed to obtain lithium sulfide.

### (2) Purification of Lithium Sulfide

After NMP in the 500 mL of the slurry reaction solution (NMP-lithium sulfide slurry) obtained in the above-mentioned (1) was subjected to decantation, 100 mL of dehydrated NMP was added thereto. Then, the mixture was stirred at 105° C. for about one hour. With the temperature being maintained, NMP was subjected to decantation. Further, 100 mL of NMP was added and stirred at 105° C. for about one hour, and NMP was subjected to decantation with the temperature being maintained. The same operation was repeated 4 times in total. After the completion of the decantation, lithium sulfide was dried under the stream of nitrogen, at 230° C. (that is a temperature which is equal to or higher than the boiling point of NMP), under ordinary pressure for 3 hours, thereby to obtain purified lithium sulfide. The content of impurities in the purified lithium sulfide obtained was measured.

The contents of sulfur oxides of lithium sulfite (Li₂SO₃), lithium sulfate (Li₂SO₄) and thiosulfuric acid dilithium salt (Li₂S₂O₃), and N-methyl aminobutyric acid lithium salt (LMAB) were determined quantitatively by means of ion chromatography. As a result, the total content of the sulfur oxides was 0.13 mass %, and the content of LMAB was 0.07 mass %.

### Production Example 2

### Production of Sulfide-based Solid Electrolyte Glass (Li₂S/P₂S₅ (molar ratio)=75/25)

### Mechanical Milling Method

Sulfide-based glass was produced using lithium sulfide which had been produced in Production

Example 1 by the method according to Example 1 described in WO07/066,539.

Specifically, sulfide-based glass was produced as follows.

0.383 g (0.00833 mol) of lithium sulfide produced in Production Example 1 and 0.618 g (0.00278 mol) of phosphorus pentasulfide (manufactured by Sigma Aldrich Co., LLC.) were well mixed. The mixed powder and 10 zirconia balls each having a diameter of 10 mm were placed in an alumina container of a planetary ball mill (P-7, manufactured by Fritsch). The container was completely sealed, and at the same time it was filled with nitrogen to create a nitrogen atmosphere therein.

For the initial several minutes, lithium sulfide and phosphorus pentasulfide were sufficiently mixed with the planetary ball mill being rotated at a lower rotation speed (85 rpm). Thereafter, the rotation speed was gradually increased to 370 rpm, and at the 370 rpm, mechanical milling was conducted for 20 hours.

As a result of the evaluation by an X-ray measurement of the white yellow powder obtained by the mechanical milling, the powder was confirmed to be vitrified (sulfide glass).

A DSC investigation of the thermophysical properties of this glass showed that the glass-transition point (Tg) was 172° C., and the crystallization temperature (Tc) was 231° C.

In addition, on the following ³¹P-NMR measurement, a first peak appeared at 85.0 ppm, the maximum value among the intensity ratios of other peaks to the first peak (Iₒₜₕₑᵣₛ/I_{first}) was 0.21.

The ³¹P-NMR measurement was conducted at room temperature by using a NMR device (JNM-CMXP302, manufactured by JOEL Ltd.) with a 5 mmCP/MAS probe. The ³¹P-NMR spectrum was measured by using the single pulse method, 90° pulse 4 μs and magic angle spinning of 8.6 kHz. The chemical shift was determined by using ammonium hydrogenphosphate (1.3 ppm) as an external reference. The measurement range was 0 to 150 rpm.

### Production Example 3

### Production of Sulfide-based Solid Electrolyte Glass (Li₂S/P₂S₅ (molar ratio)=75/25

### Slurry Method

Sulfide-based glass was produced using lithium sulfide produced in Production Example 1 by the same method as in Example 1 described in JP-A-2010-140893.

Specifically, the production was performed as follows.

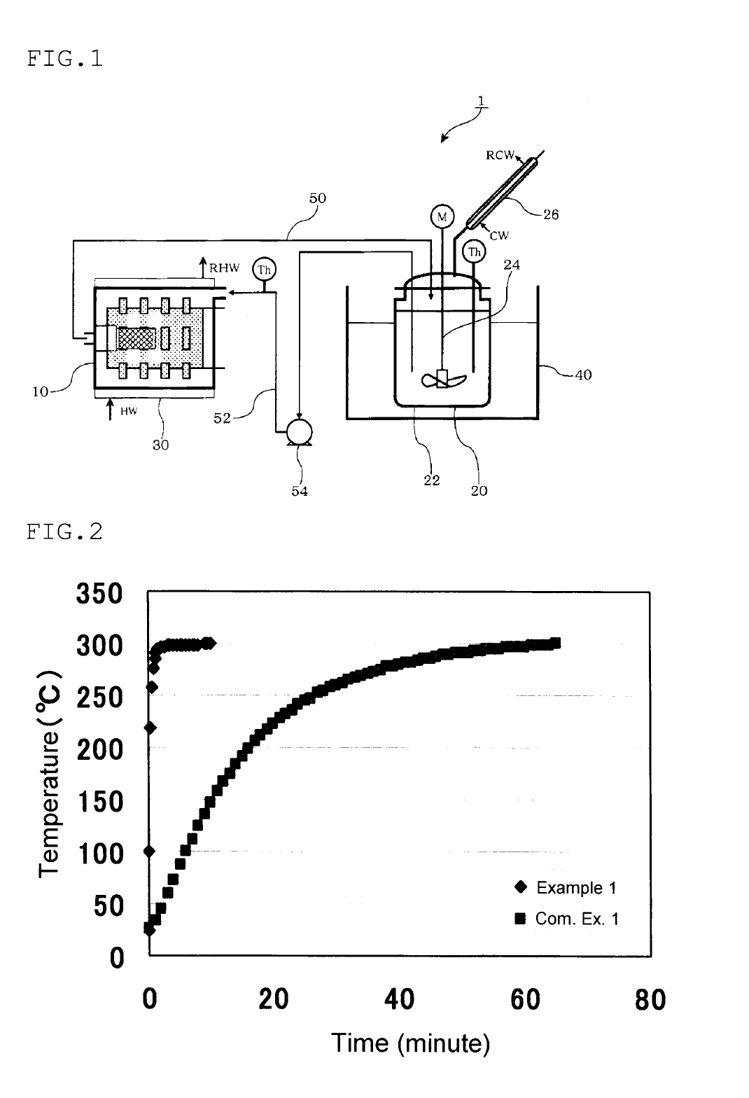

Sulfide-based glass ceramics was produced by using an apparatus 1 shown in FIG. 1. A bead mill “Star Mill Miniature” (0.15 L) (manufactured by Ashizawa Finetech Ltd.) was used as a stirrer 10. 450 g of zirconia balls each having a diameter of 0.5 mm were charged. A glass reactor (1.5 L) equipped with a stirrer was used as a reaction vessel 20.

A mixture prepared by adding 1080 g of dehydrated toluene (water content: 8 ppm) (manufactured by Hiroshima Wako Co., Ltd.) to 45.90 g (75 mol %) of lithium sulfide produced in Production Example 1 and 74.10 g (25 mol %) of phosphorus pentasulfide (manufactured by Aldrich) was put in the reaction vessel 20 and the stirrer 10.

The mixture was circulated at a flow rate of 400 ml/min using a pump 54 in the reaction vessel 20 and the stirrer 10, and the reaction vessel 20 was heated to 80° C.

Hot water was externally circulated into the stirrer 10 so that the liquid temperature was maintained at 70° C., and the stirrer was operated at a circumferential speed of 8 m/s. Every 2 hours, slurry was collected. The collected slurry was dried at 150° C. to obtain white powder. For the powder obtained after the reaction for 12 hours, an X-ray diffraction measurement was conducted. As a result, it was found that lithium sulfide almost disappeared, while remaining slightly, showing that lithium sulfide was substantially vitrified.

A DSC investigation of the thermophysical properties of the glass showed that the glass-transition point (Tg) was 170° C., and the crystallization temperature (Tc) was 230° C.

In addition, the ³¹P-NMR measurement was performed as in the same manner as in Production Example 2. As a result, a first peak appeared at 84.9 ppm, and the maximum value among the intensity ratios of other peaks to the first peak was 0.19.

### Production Example 4

### Production of Sulfide-based Solid Electrolyte Glass (Li₂S/P₂S₅/LiI (molar ratio)=63/21/16

### Mechanical Milling Method

Sulfide-based solid electrolyte glass was obtained in the same manner as in Production Example 2, except that as raw materials, 0.781 g of sulfide-based solid electrolyte obtained in Production Example 2 and 0.221 g of lithium iodide were used.

A DSC investigation of the thermophysical properties of the glass showed that the glass-transition point (Tg) was 155° C., and the crystallization temperature (Tc) was 192° C.

In addition, the ³¹P-NMR measurement was performed as in the same manner as in Production Example 2. As a result, a first peak appeared at 83.0 ppm, and the maximum value among the intensity ratios of other peaks to the first peak was 0.08.

### Production Example 5

### Production of Sulfide-based Solid Electrolyte Glass (Li₂S/P₂S₅/LiI (molar ratio)=52/17/31

### Mechanical Milling Method-)

Sulfide-based solid electrolyte glass was obtained in the same manner as in Production Example 2, except that as raw materials, 0.600 g of sulfide-based solid electrolyte obtained in Production Example 2 and 0.400 g of lithium iodide were used

A DSC investigation of the thermophysical properties of the glass showed that the glass-transition point (Tg) was 130° C. and the crystallization temperature (Tc) was 162° C.

In addition, the ³¹P-NMR measurement was performed in the same manner as in Production Example 2. As a result, a first peak appeared at 83.1 ppm, and the maximum value among the intensity ratios of other peaks to the first peak was 0.12.

### Production Example 6

### Production of Sulfide-based Solid Electrolyte Glass (Li₂S/P₂S₅ (molar ratio)=80/20

### Mechanical Milling Method

The same operation was conducted as in Production Example 2, except that the amount of lithium sulfide was changed to 0.453 g (0.00985 mol) and the amount of phosphorous pentasulfide was changed to 0.548 g (0.00246 mol). On the X-ray diffraction measurement, it was found that lithium sulfide as a raw material almost disappeared while remaining slightly, showing that lithium sulfide was substantially vitrified.

A DSC investigation of the thermophysical properties of the glass showed that the glass-transition point (Tg) was 184° C., and the crystallization temperature (Tc) was 226° C.

In addition, the ³¹P-NMR measurement was performed in the same manner as in Production Example 2. As a result, a first peak appeared at 85.2 ppm, and the maximum value among the intensity ratios of other peaks to the first peak was 0.11.

### Production Example 7

### Production of Sulfide-based Solid Electrolyte Glass (Li₂S/P₂S₅ (molar ratio)=70/30

### Mechanical Milling Method

Sulfide-based solid electrolyte glass was obtained in the same manner as in Production Example 2, except that the amount of lithium sulfide was changed to 0.326 g (0.00709 mol) and the amount of phosphorous pentasulfide was changed to 0.674 g (0.00303 mol).

A DSC investigation of the thermophysical properties of the glass showed that the glass-transition point (Tg) was 205° C. and the crystallization temperature (Tc) was 236° C.

In addition, the ³¹P-NMR measurement was performed in the same manner as in Production Example 2. As a result, a main peak appeared at 89.4 ppm. Some peaks lower than the main peak appeared. However, in the region from 81.0 ppm to 88.0 ppm, no peak was observed (no first peak).

### Example 1

### Heat Treatment of Sulfide-based Solid Electrolyte Glass

300 mg of the sulfide-based solid electrolyte glass obtained in Production Example 2 was formed into a cylindrical shape with a diameter of 10 mm by powder compacting. The powder compact obtained was sandwiched between two stainless plates heated to 300° C. At this time, the temperature of powder compact was elevated to nearly 300° C. for about 2 minutes. Thus, the average temperature elevation rate was about 140° C./min. FIG. 2 shows the relationship between the temperature of powder compact and heating times.

The ³¹P-NMR measurement was performed in the same manner as in Production Example 2. As a result, a first peak appeared at 85.2 ppm, the maximum value among the intensity ratios of other peaks to the first peak was 0.07.

After that, the powder compact was heated for 10 minutes with the state being maintained. The measurement of the ionic conductivity a of the powder compact after heating showed that the value was 9.9×10⁻⁴S/cm.

The ionic conductivity (σ) was measured as follows.

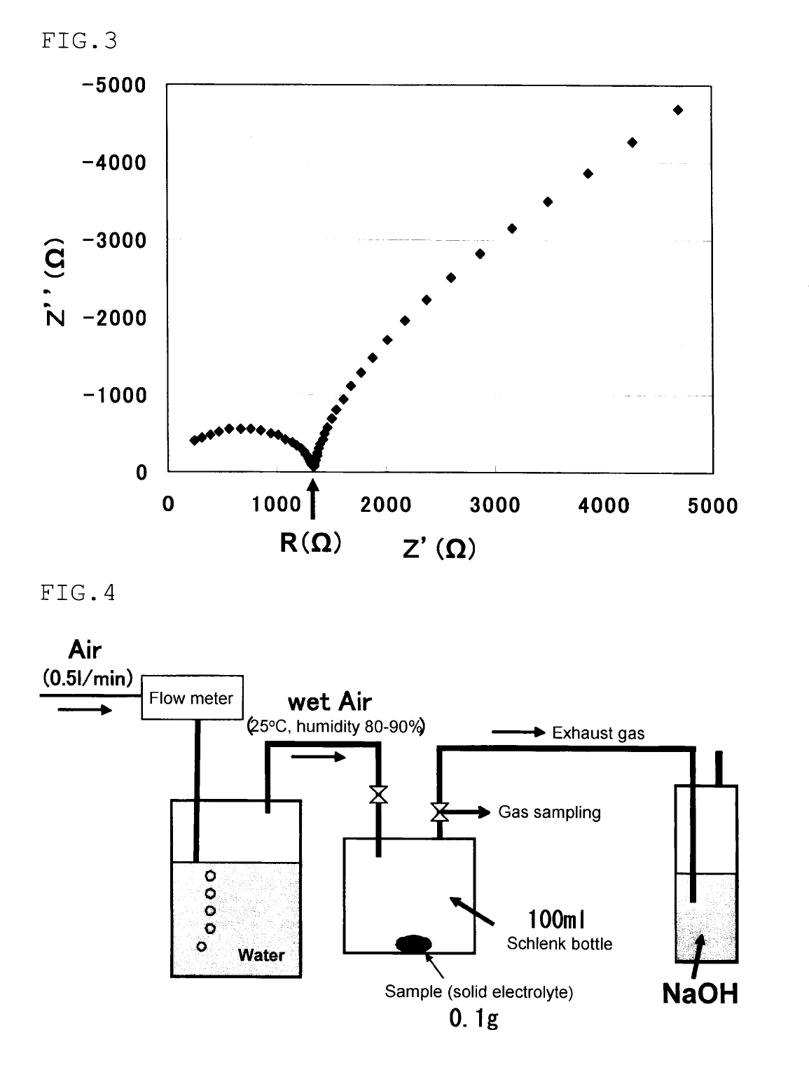

First, 200 mg to 300 mg of an electrolyte material was formed to a cylindrical shape with a diameter of 10 mm by powder compacting to obtain a sample for measurement (sample cross-section S=0.785 cm²). The height of the cylindrical sample (L(cm)) was measured by a vernier caliper. Electrode terminals were attached to the upper and bottom sides of the sample piece obtained as a powder compact, and the ionic conductivity was measured by the alternating current impedance method (frequency range: 5 MHz to 0.5 Hz) to obtain a Cole-Cole plot. The result is shown in FIG. 3.

The real part Z′ (O) of the point where —Z″ (Ω) is the smallest near the right end of a circular arc observed in the higher-frequency region was taken as the bulk resistance R(Ω) of an electrolyte. According to the following formula, the ionic conductivity σ was calculated.

R=p(L/S),σ=1/p

Meanwhile, if the distance of a lead from the one side of a sample to a measuring instrument is long, a circular arc may not clearly be observed. In the examples, the measurement was conducted with the distance of a lead being about 60 cm.

Next, the heated powder compact was pulverized by means of a mortar to evaluate the hydrolysis resistance of the sample. The hydrolysis resistance was evaluated by measuring the average hydrogen sulfide concentration according to the following method. The average hydrogen sulfide concentration was 20.2 ppm. The results are shown in Table 1.

The average hydrogen sulfide concentration was determined by measuring the amount of generated lithium sulfide with an apparatus shown in FIG. 4.

First, a sample was pulverized by means of a mortar in a glovebox with nitrogen under a circumstance having a dew point of −80° C. 0.1 g of the pulverized sample was encapsulated in a 100 ml-Schlenk bottle. The Schlenk bottle was set at the place shown in FIG. 4.

Next, air that had been passed through water was circulated in the Schlenk bottle at 500 ml/min. The humidity of air in the Schlenk bottle right after the beginning of circulation was 80 to 90%. Gas discharged from the Schlenk bottle between one minute and one minute 45 seconds after the beginning of circulation was collected to obtain a first sample gas.

The hydrogen sulfide concentration of the sample gas was calculated by determining quantitatively the sulfur content thereof by the ultraviolet fluorescent method using TS-100 manufactured by Mitsubishi Chemical Analytech Co., Ltd. Meanwhile, the sample gas was analyzed qualitatively by means of gas chromatography by using Agilent 6860 (with a sulfur selective detector (SIEVERS355) attached). As a result, 99% or more of the sulfur content was confirmed to be a hydrogen sulfide gas.

For gases discharged from the Schlenk bottle between 5 minutes to 5 minutes 45 seconds after the beginning of circulation, between 10 minutes to 10 minutes 45 seconds after the beginning of circulation, between 20 minutes to 20 minutes 45 seconds after the beginning of circulation and between 60 minutes to 60 minutes 45 seconds after the beginning of circulation, the measurement was conducted as is the case with the first sample gas.

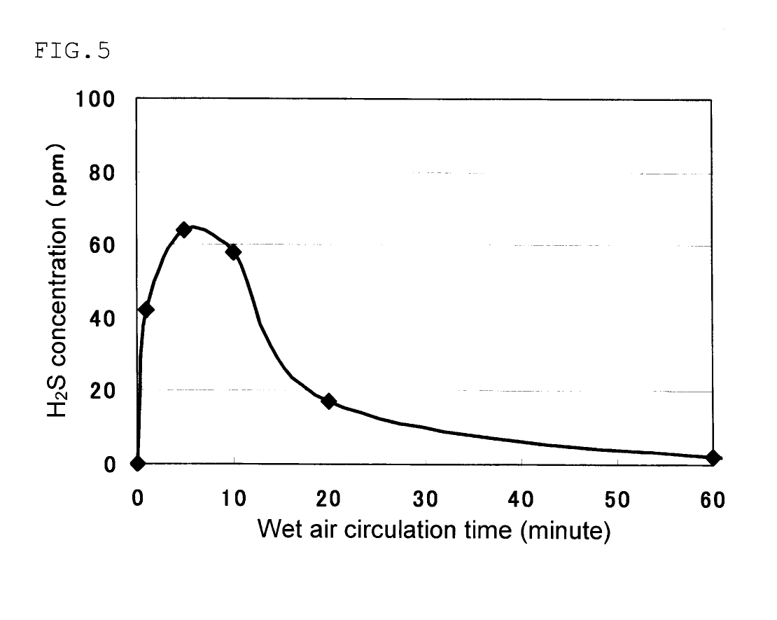

FIG. 5 shows an example of the relationship between the circulation time of wet air and the concentration of hydrogen sulfide. The curve was obtained by subjecting each measurement point to smoothing. The area (ppm·minute) bounded by the curve, vertical axis, and horizontal axis was divided by time (60 minutes) to obtain the average hydrogen sulfide concentration (ppm).

Moreover, a powder compact was made again from the sample pulverized by means of a mortar, and the powder compact was measured for the ionic conductivity. The measured value was almost similar to the above-mentioned value. From this, it was confirmed that a high ionic conductivity obtained in this Example was not attributed to the fusion effect shown in Non-Patent Document 1.

### Example 2

### Heat Treatment of Sulfide-based Solid Electrolyte Glass

The ionic conductivity a and the average hydrogen sulfide concentration were measured by performing a heat treatment in the same manner as in Example 1, except that the temperature of the stainless plates was changed to 250° C. The result is shown in Table 1. The average temperature elevation rate was about 110° C./min.

The ³¹P-NMR measurement was performed in the same manner as in Production Example 2. As a result, a first peak appeared at 84.9 ppm, and the maximum value among the intensity ratios of other peaks to the first peak was 0.07.

Moreover, a powder compact was made again from the sample pulverized by means of a mortar, and the powder compact was measured for the ionic conductivity. The measured value was almost similar to the above-mentioned value. From this, it was confirmed that a high ionic conductivity obtained in this Example was not attributed to the fusion effect shown in Non-Patent Document 1.

### Example 3

### Heat Treatment of Sulfide-based Solid Electrolyte Glass

The ionic conductivity a and the average hydrogen sulfide concentration were measured by performing a treatment in the same manner as in Example 1, except that the heating treatment time was changed to one minute. The results are shown in Table 1. The average temperature elevation rate was about 140° C./min.

The ³¹P-NMR measurement was performed in the same manner as in Production Example 2. As a result, a first peak appeared at 85.2 ppm, and the maximum value among the intensity ratios of other peaks to the first peak was 0.08.

Moreover, a powder compact was made again from the sample pulverized by means of a mortar, and the powder compact was measured for the ionic conductivity. The measured value was almost similar to the above-mentioned value. From this, it was confirmed that the high ionic conductivity obtained in this Example was not attributed to the fusion effect mentioned in Non-Patent Document 1.

### Example 4

### Heating Treatment of Sulfide-Based Solid Electrolyte Glass

The ionic conductivity σ and the average hydrogen sulfide concentration were measured by performing a heat treatment in the same manner as in Example 1, except that sulfide-based electrolyte glass obtained in Production Example 3 was used. The results are shown in Table 1. The average temperature elevation rate was about 140° C./min.

The ³¹P-NMR measurement was performed in the same manner as in Production Example 2. As a result, a first peak appeared at 85.2 ppm, and the maximum value among the intensity ratios of other peaks to the first peak was 0.08.

Moreover, a powder compact was made again from the sample pulverized by means of a mortar, and the powder compact was measured for the ionic conductivity. The measured value was almost similar to the above-mentioned value. From this, it was confirmed that a high ionic conductivity obtained in this Example was not attributed to the fusion effect described in Non-Patent Document 1.

### Example 5

### Heat Treatment of Sulfide-Based Solid Electrolyte Glass

The ionic conductivity a and the average hydrogen sulfide concentration were measured by performing a heat treatment in the same manner as in Example 1, except that the sulfide-based electrolyte glass obtained in Production Example 4 was used, the temperature of the stainless plates was changed to 210° C. and the heat treatment time was changed to one minute. The results are shown in Table 1. The average temperature elevation rate was about 120° C./min.

The ³¹P-NMR measurement was performed in the same manner as in Production Example 2. As a result, a first peak appeared at 83.1 ppm, and the maximum value among the intensity ratios of other peaks to the first peak was 0.06.

Moreover, a powder compact was made again from the sample pulverized by means of a mortar, and the powder compact was measured for the ionic conductivity. The measured value was almost similar to the above-mentioned value. From this, it is confirmed that the high ionic conductivity obtained in Examples of the invention was not attributed to the fusion effect described in Non-Patent Document 1.

### Example 6

### Heat Treatment of Sulfide-based Solid Electrolyte Glass

The ionic conductivity a and the average hydrogen sulfide concentration were measured by performing a heat treatment in the same manner as in Example 1, except that the sulfide-based electrolyte glass obtained in Production Example 5 was used and the temperature of heat treatment was changed to 210° C. The results are shown in Table 1. The average temperature elevation rate was about 120° C./min.

The ³¹P-NMR measurement was performed in the same manner as in Production Example 2. As a result, a first peak appeared at 83.0 ppm, the maximum value among the intensity ratios of other peaks to the first peak was 0.07.

Moreover, a powder compact was made again from the sample pulverized by means of a mortar, and the powder compact was measured for the ionic conductivity. The measured value was almost similar to the above-mentioned value. From this, it is confirmed that a high ionic conductivity obtained in Examples of the invention was not attributed to fusion effect shown in Non-Patent Document 1.

### Example 7

### Heat Treatment of Sulfide-based Solid Electrolyte Glass)

The ionic conductivity a and the average hydrogen sulfide concentration were measured by performing a heat treatment in the same manner as in Example 1, except that the sulfide-based electrolyte glass obtained in Production Example 6 was used. The results are shown in Table 1. The average temperature elevation rate was about 140° C./min.

The ³¹P-NMR measurement was performed in the same manner as in Production Example 2. As a result, a first peak appeared at 85.0 ppm and the maximum value among the intensity ratios of other peaks to the first peak was 0.12.

Moreover, a powder compact was made again from the sample pulverized by means of a mortar, and the powder compact was measured for the ionic conductivity. The measured value was almost similar to the above-mentioned value. From this, it was confirmed that the high ionic conductivity obtained in this Example was not attributed to the fusion effect described in Non-Patent Document 1.

### Comparative Example 1

### Heat Treatment of Sulfide-based Solid Electrolyte Glass

The sulfide-based solid electrolyte glass powder obtained in Production Example 2 was put in a stainless tube. The stainless tube was set in an oven heated previously at 300° C. and left alone for 2 hours. 300 mg of the powder was formed to a cylindrical shape with a diameter of 10 mm by powder compacting. The ionic conductivity a of the powder compact was measured in the same manner as in Example 1. The average temperature elevation rate was about 5° C./min.

The ³¹P-NMR measurement was performed in the same manner as in Production Example 2. As a result, a first peak appeared at 85.1 ppm and the maximum value among the intensity ratios of other peaks to the first peak was less than 0.10.

In addition, the powder compact was pulverized by a mortar to obtain a sample. For the sample, the average hydrogen sulfide concentration was measured in the same manner as in Example 1. The results are shown in Table 1.

Moreover, a powder compact was made again from the sample pulverized by means of a mortar, and the powder compact was measured for the ionic conductivity. The measured value was almost similar to the above-mentioned value.

Meanwhile, since heating was conducted in an oven, it took about 60 minutes for the sulfide-based solid electrolyte glass powder to reach 300° C. Thus, the average temperature elevation rate during this heating was about 5° C./min. FIG. 2 shows the relationship between the temperature of glass powder and the heating time.

### Comparative Example 2

### Heat Treatment of Sulfide-based Solid Electrolyte Glass

A heat treatment was conducted in the same manner as in Example 1, except that the sulfide-based solid electrolyte glass obtained in Production Example 7 was used. The ionic conductivity σ and the average hydrogen sulfide concentration were measured. The results are shown in Table 1. Meanwhile, the average temperature elevation rate was about 140° C./min.

The ³¹P-NMR measurement was performed in the same manner as in Production Example 2. As a result, peaks appeared at 86.1 ppm (first peak) and 91.2 ppm. The intensity ratio of the latter peak to the former peak was 1.17.

Moreover, a powder compact was made again from the sample pulverized by means of a mortar, and the powder compact was measured for the ionic conductivity. The measured value was almost similar to the above-mentioned value.

Each of the sulfide-based glass ceramics of Examples 1 to 7 had a high ionic conductivity. In addition, they had an excellent hydrolysis resistance. Therefore, they can be used in a condition having a relative high dew point. Such materials have not been known so far.

Although the sulfide-based glass ceramics in Comparative Example 1 had an excellent hydrolysis resistance, the ionic conductivity was low, and hence, it is not suited for use in battery applications. The sulfide-based glass ceramics in Comparative Example 2 had a high ionic conductivity, but the hydrolysis resistance was low. It is difficult to increase the dew point of work environment where this material is used.

TABLE 1

| | Electrolyte precursor | | | | | | | | | |
|---|---|---|---|---|---|---|---|---|---|---|
| | | | Maximum | | | | | | | |
| | | | value | | | | | | | |
| | | | of peak | | | | Solid electrolyte after heat treatment | | | |
| | | | intensity | Heat treatment | | | | Maximum value | | Average |
| | | First peak | ratio with | Temperature | Heat | Heat | First peak | of peak intensity | | concentration |
| | Production | position of | other | elevation | treatment | treatment | position of | ratio with other | Ionic | of hydrogen |
| | example of | ³¹P-NMR | peaks | ratio | temperature | time | ³¹P-NMR | peaks | conductivity | sulfide |
| | precursor | (ppm) | (Iₒₜₕₑᵣ/I_{first}) | (° C./min) | (° C.) | (min) | (ppm) | (Iₒₜₕₑᵣ/I_{first}) | σ (S/cm) | (ppm) |
| Ex. 1 | Pro. Ex. 2 | 85.0 | 0.21 | About 140 | 300 | 10 | 85.2 | 0.07 | 9.9 × 10⁻⁴ | 20.2 |
| Ex. 2 | Pro. Ex. 2 | 85.0 | 0.21 | About 110 | 250 | 10 | 84.9 | 0.07 | 7.7 × 10⁻⁴ | 18.9 |
| Ex. 3 | Pro. Ex. 2 | 85.0 | 0.21 | About 140 | 300 | 1 | 85.2 | 0.08 | 7.0 × 10⁻⁴ | 15.7 |
| Ex. 4 | Pro. Ex. 3 | 84.9 | 0.19 | About 140 | 300 | 10 | 85.2 | 0.08 | 1.1 × 10⁻³ | 15.1 |
| Ex. 5 | Pro. Ex. 4 | 83.0 | 0.08 | About 120 | 210 | 1 | 83.1 | 0.06 | 7.0 × 10⁻⁴ | 13.3 |
| Ex. 6 | Pro. Ex. 5 | 83.1 | 0.12 | About 120 | 210 | 10 | 83.0 | 0.07 | 5.3 × 10⁻⁴ | 14.2 |
| Ex. 7 | Pro. Ex. 6 | 85.2 | 0.11 | About 140 | 300 | 10 | 85.0 | 0.12 | 1.8 × 10⁻³ | 15.6 |
| Com. | Pro. Ex. 2 | 85.0 | 0.21 | About 5 | 300 | About 60 | 85.1 | Less than 0.10 | 1.6 × 10⁻⁴ | 21.5 |
| Ex. 1 | | | | | | | | | | |
| Com. | Pro. Ex. 7 | — | — | About 140 | 300 | 10 | 86.1 | 1.17 | 2.1 × 10⁻³ | 308 |
| Ex. 2 | | | | | | | | | | |

### INDUSTRIAL APPLICABILITY

The solid electrode material of the invention can be used in elements for a lithium ion battery.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the Japanese patent applications claiming the priority under the Paris Convention to the invention are incorporated herein by reference in its entirety.

1. A solid electrolyte comprising, as constituent components, lithium, phosphorous and sulfur;
wherein,
in the ³¹P-NMR,
the solid electrolyte has a peak (first peak) in a region of 81.0 ppm or more and 88.0 ppm or less,
the solid electrolyte does not have a peak in regions other than the region of 81.0 ppm or more and 88.0 ppm or less,
or even if it has a peak in other regions than the region of 81.0 ppm or more and 88.0 ppm or less, a peak intensity thereof relative to the first peak is 0.5 or less, and the solid electrolyte has an ionic conductivity of 5×10⁻⁴ S/cm or more.

2. A solid electrolyte comprising, as constituent components, lithium or sodium; phosphorous; and sulfur:
wherein the solid electrolyte has an ionic conductivity of 5×10⁻⁴ S/cm or more, and
when air having a humidity of 80 to 90% is passed through a 100 ml-container filled with 0.1 g of the solid electrolyte at a rate of 500 ml/min for 60 minutes, an average of a hydrogen sulfide concentration in the air is 200 ppm or less.

3. The solid electrolyte according to claim 2, wherein the solid electrolyte is obtained by:
elevating a temperature of glass comprising, as constituent components: lithium or sodium; phosphorous; and sulfur, at an average temperature elevation rate of 20° C./min or more; and
heating at a temperature for a time period of from 0.005 minute to 10 hours, wherein the temperature is equal to or higher than a glass transition temperature of the glass and that is equal to or lower than a crystallization temperature of the glass plus 120° C.

4. The solid electrolyte according to claim 1, wherein, when air having a humidity of 80 to 90% is passed through a 100 ml-container filled with 0.1 g of the solid electrolyte at a rate of 500 ml/min for 60 minutes, an average of a hydrogen sulfide concentration in the air is 200 ppm or less.

5. The solid electrolyte according claim 1, further comprising a halogen as a constituent component.

6. An electrolyte layer comprising the solid electrolyte according to claim 1.

7. An electrolyte layer that is produced by employing the solid electrolyte according to claim 1.

8. An electrode comprising the solid electrolyte according to claim 1.

9. An electrode that is produced by employing the solid electrolyte according to claim 1.

10. A battery comprising the electrolyte layer according to claim 6.

11. A battery comprising a positive electrode layer, an electrolyte layer, and a negative electrode layer, wherein at least one of the positive electrode layer, the electrolyte layer and the negative electrode layer is produced by employing the solid electrolyte according to claim 1.

12. A method for producing a solid electrolyte comprising:
elevating a temperature of glass comprising: lithium or sodium; phosphorous; and sulfur at an average temperature elevation rate of 20° C./min or more; and
heating the glass at a temperature for a time period of 0.005 minute to 10 hours, wherein the temperature is equal to or higher than a glass transition temperature of the glass and that is equal to or lower than a crystallization temperature of the glass plus 120° C.

13. The method for according to claim 12,
wherein
in the ³¹P-NMR,
the solid electrolyte has a peak (first peak) in a region of 81.0 ppm or more and 88.0 ppm or less,
the solid electrolyte does not have a peak in regions other than the region of 81.0 ppm or more and 88.0 ppm or less,
or even if it has a peak in regions other than the region of 81.0 ppm or more and 88.0 ppm or less, a peak intensity thereof relative to the first peak is 0.5 or less, and
the solid electrolyte has an ionic conductivity of 5×10⁻⁴ S/cm or more.

14. The method according to claim 12, wherein the solid electrolyte has an ionic conductivity of 5×10⁻⁴ S/cm or more, and
when air having a humidity of 80 to 90% is passed through a 100 ml-container filled with 0.1 g of the solid electrolyte at a rate of 500 ml/min for 60 minutes, an average of a hydrogen sulfide concentration in the air is 200 ppm or less.

15. The method according to claim 12, wherein the glass is heated together with a compound comprising a halogen element.

16. A battery, comprising the electrode according to claim 8.

17. The method according to claim 12, wherein the time period for heating is 0.01 minute or longer and 3 hours or shorter.

18. The method according to claim 12, wherein the average temperature elevation rate is 50° C./min or more.

19. The method according to claim 12, wherein the raw material of the glass comprises at least lithium sulfide and phosphorous pentasulfide.

20. The method according to claim 12, wherein the time period for heating is 0.01 minute or longer and 3 hours or shorter, the average temperature elevation rate is 50° C./min or more, and the raw material of the glass comprises at least lithium sulfide and phosphorous pentasulfide.
